(19) United States
(12) Patent Application Publication
(10) Pub. No.: US 2011/0199416 A1
(43) Pub. Date: Aug. 18, 2011

(54) IMAGE FORMING APPARATUS AND METHOD OF INKJET HAVING HUMIDITY ADJUSTMENT MECHANISM

(75) Inventors: Nobuaki Takahashi, Shizuoka-ken (JP); Atsushi Kubota, Shizuoka-ken (JP); Takashi Hatakeyama, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/026,433

(22) Filed: Feb. 14, 2011

Related U.S. Application Data
(60) Provisional application No. 61/305,388, filed on Feb. 17, 2010.

(51) Int. Cl. B41J 29/38

(52) U.S. Cl. 347/16

(57) ABSTRACT

According to one embodiment, an ink-jet image forming apparatus includes an ink-jet head which ejects water-based ink and form an image on a surface of a recording medium, a medium conveying unit which conveys the recording medium, a solution applying unit arranged further on an upstream side in a recording medium conveying direction than the ink-jet head and which applies water solution to a surface of the recording medium on which an image is formed, and a controller configured to calculate an application amount of the water solution to apply the water solution to the recording medium at 1% to 6% of weight of the recording medium and control an application operation to the recording medium.

### CROSS-REFERENCE TO RELATED APPLICATIONS

This application is based upon and claims the benefit of U.S. Provisional Applications No. 61/305,388, filed on Feb. 17, 2010; the entire contents of which are incorporated herein by reference.

### FIELD

Embodiments described herein relate generally to an ink-jet image forming apparatus including a mechanism which humidifies a medium and an image forming method.

### BACKGROUND

In the past, there has been a problem in that, when an image is formed using water-based ink, deformation (cockling and curl) of paper due to moisture in the ink occurs. When the cockled paper is conveyed, the paper collides with components in a printing apparatus such as a print head to cause a paper jam. Even after the cockled paper is discharged to the outside of the apparatus, since the cockling is not eliminated, when pieces of the paper are stacked, the thickness of the stacked pieces of the paper increases. Therefore, it is difficult to handle the paper.

In the past, there is known a technique for preventing the collision of the cockled paper and the components. However, the technique specifies handling of paper deformed by printing. Therefore, there is a demand for a reduction in the deformation caused in the paper by the printing.

### BRIEF DESCRIPTION OF THE DRAWINGS

FIG. 1 is a diagram of an exemplary schematic configuration of an ink-jet image forming apparatus according to an embodiment;

FIG. 2 is a diagram of an exemplary configuration of a conveyor belt according to the embodiment;

FIG. 3 is a diagram of an exemplary configuration of a medium conveying unit according to the embodiment;

FIG. 4 is a diagram of an exemplary configuration of a head mounted unit according to the embodiment;

FIG. 5 is a diagram of an exemplary configuration of an ink-jet head according to the embodiment;

FIG. 6 is a diagram of an exemplary configuration of an atomizer according to the embodiment;

FIG. 7 is a diagram of an exemplary configuration of solution applying rollers according to the embodiment;

FIG. 8 is a diagram of an exemplary configuration of a control system of an ink-jet image forming apparatus according to the embodiment;

FIG. 9 is an exemplary flowchart for explaining an image forming operation procedure of the ink-jet image forming apparatus according to the embodiment; and

FIG. 10 is an exemplary diagram for explaining an effect of a reduction in cockling realized when moisture is applied in the ink-jet image forming apparatus according to the embodiment.

### DETAILED DESCRIPTION

In general, according to one embodiment, an ink-jet image forming apparatus includes an ink-jet head which ejects water-based ink and form an image on a surface of a recording medium; a medium conveying unit which conveys the recording medium; a solution applying unit arranged further on an upstream side in a recording medium conveying direction than the ink-jet head and which applies water solution to a surface of the recording medium on which an image is formed; and a controller configured to calculate an application amount of the water solution to apply the water solution to the recording medium at 1% to 6% of weight of the recording medium and control an application operation to the recording medium.

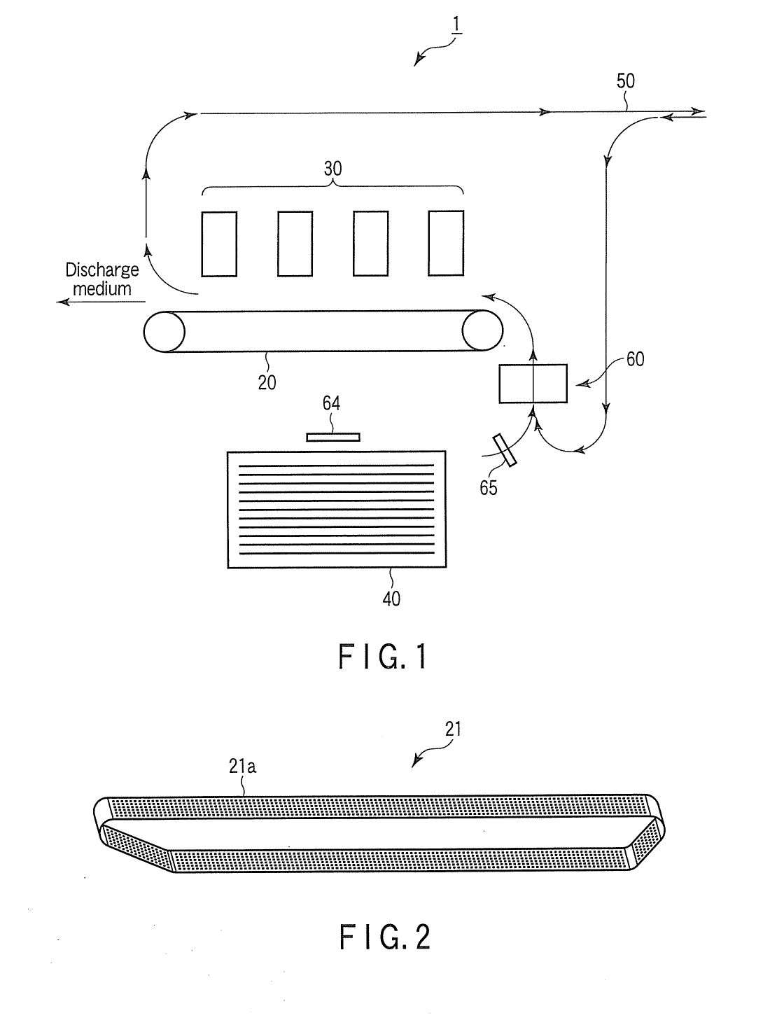

FIG. 1 is a diagram of an exemplary schematic configuration of an ink-jet image forming apparatus according to an embodiment.

An ink-jet image forming apparatus 1 includes a medium conveying unit 20, an ink-jet-head mounted unit 30, a medium storing unit 40, a medium reversing unit 50, a solution applying unit 60, a temperature and humidity detection sensor 64, and a paper thickness detection sensor 65.

The medium conveying unit 20 conveys a medium. The ink-jet-head mounted unit 30 forms an image on the medium. The medium storing unit 40 stores media such as paper on which images are formed. The medium reversing unit 50 reverses the medium. The solution applying unit 60 applies a solution to a surface of the medium to be printed. The temperature and humidity detection sensor 64 detects temperature and humidity in the medium storing unit 40. The paper thickness detection sensor 65 detects the thickness of a medium extracted from the medium storing unit 40 to form an image thereon.

A schematic operation of the ink-jet image forming apparatus 1 is explained below. The ink-jet image forming apparatus 1 has a simplex printing mode and a duplex printing mode as printing modes.

In the case of the simplex printing mode, the solution applying unit 60 applies the solution to a surface to be printed of the medium extracted from the medium storing unit 40. The medium conveying unit 20 conveys the medium. During the conveyance, the ink-jet-head mounted unit 30 forms an image on the medium. The medium is discharged to the outside of the apparatus.

In the case of the duplex printing mode, the medium is further conveyed in the ink-jet image forming apparatus 1. The medium reversing unit 50 reverses the medium and feeds the medium to the solution applying unit 60 again. The solution applying unit 60 applies the solution to a surface to be printed of the reversed medium. The ink-jet-head mounted unit 30 forms an image on the reversed medium while the medium conveying unit 20 conveys the medium. Thereafter, the medium is discharged to the outside of the ink-jet image forming apparatus 1.

FIG. 2 is a diagram of an exemplary configuration of a conveyor belt according to this embodiment.

A conveyor belt 21 is an endless belt manufactured by laminating rubber on fiber and polishing the surface of the rubber. A large number of holes 21a are formed on the entire surface of the conveyor belt 21. The conveyor belt 21 is not limited to this form and may be manufactured by integrally molding resin such as polyimide or may be manufactured by terminating an open-end belt of stainless steel or the like.

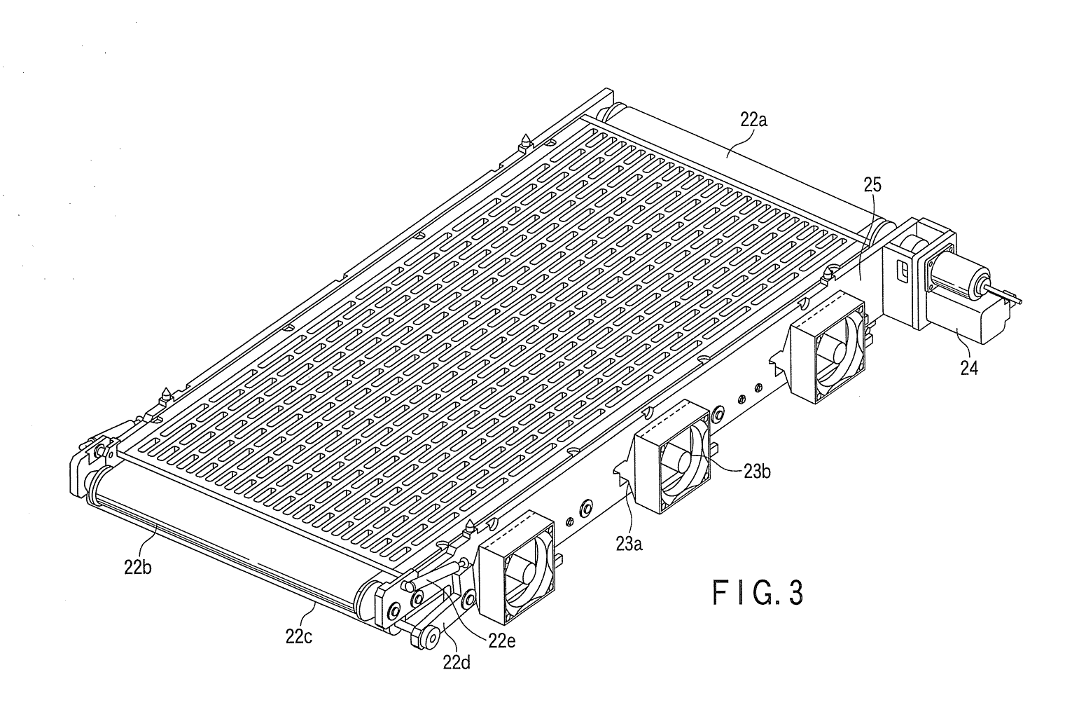

FIG. 3 is a diagram of an exemplary configuration of a medium conveying unit according to this embodiment.

The medium conveying unit 20 includes a driving roller 22a, a driven roller 22b, a tension roller 22c, a duct 23a, a suction fan 23b, a driving unit 24, and a housing 25.

The driving roller 22a and the driven roller 22b corresponding to the driving roller 22a drive the conveyor belt 21. The tension roller 22c applies tension to the conveyor belt 21. The duct 23a attracts a medium to the conveyor belt 21 via the conveyor belt 21. The suction fan 23b sucks the air to attract the medium. The driving unit 24 drives the driving roller 22a. The housing 25 integrally houses the units.

The housing 25 includes a tensioner 22d and a tension spring 22e configured to support the tension roller 22c.

The operation of the medium conveying unit 20 is explained below.

The driving roller 22a receives driving force from the driving unit 24 and rotates the conveyor belt 21 in a desired direction. At this point, a medium conveying surface of the conveyor belt 21 is formed by a top plate provided in the duct 23a. The suction fan 23b is arranged in the duct 23a. A large number of holes are provided on the top plate. Suction force generated by the suction fan 23b acts on the medium via the duct 23a, the top plate, and the holes 21a on the conveyor belt 21. Consequently, the medium adheres to the medium conveying surface of the conveyor belt 21. The medium is conveyed at desired speed together with the conveyor belt 21.

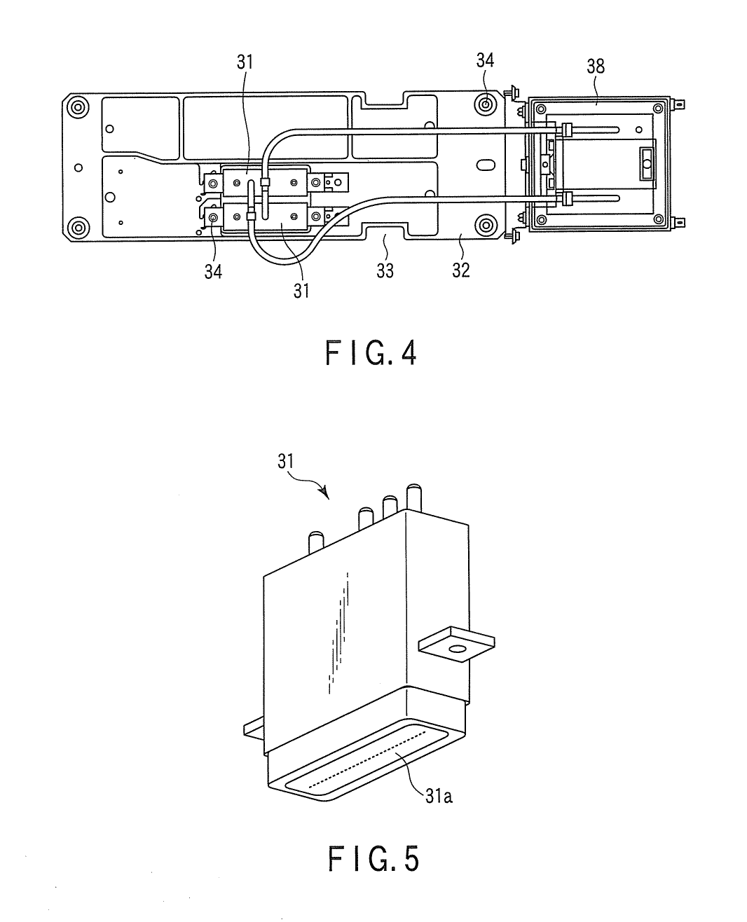

FIG. 4 is a diagram of an exemplary configuration of a head mounted unit according to this embodiment.

The ink-jet-head mounted unit 30 includes one or plural ink-jet heads 31, a head base 32, a sensor 33, and an ink tank 38.

The number of the ink-jet heads 31 depends on an image forming range, resolution, the number of colors, and the like. The head base 32 fixes the ink-jet heads 31. The sensor 33 detects a medium. The ink tank 38 supplies ink.

FIG. 5 is a diagram of an exemplary configuration of the ink-jet head 31 according to this embodiment.

The ink-jet head 31 includes a nozzle section 31a opposed to the medium conveying surface and an ejecting mechanism configured to eject ink from the nozzle section 31a. The ink-jet head 31 ejects the ink to the medium to form an image on the medium.

When the ink-jet-head mounted unit 30 includes the plural ink-jet heads 31, the ink-jet heads 31 are fixed by screws 34 incorporating spring washers such that the ink-jet heads 31 can be fixed with the positions of the ink-jet heads 31 adjusted. When a plurality of the head bases 32 are arranged, to adjust relative positions of the respective head bases 32, a fixing mechanism by the springs 34 incorporating the spring washers is provided as in the ink-jet heads 31.

The solution applying unit 60 is explained below. The solution applying unit 60 includes an atomizer or at least one or more solution applying rollers.

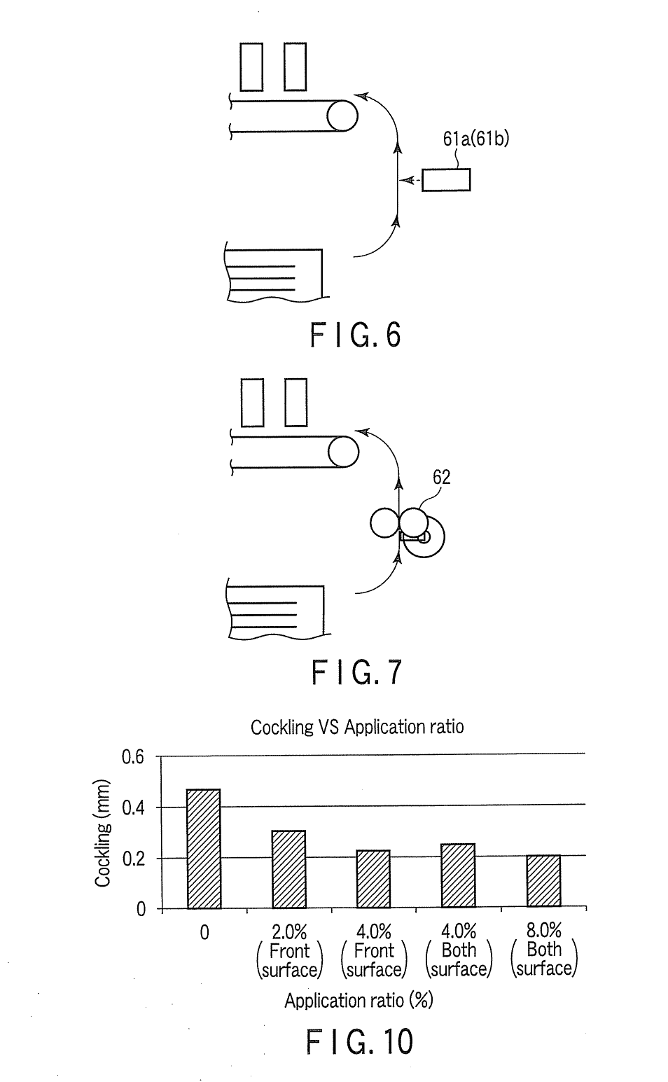

FIG. 6 is a diagram of an exemplary configuration of an atomizer according to this embodiment.

An atomizer 61 is an ultrasonic atomizer 61a configured to change a solution into a micro-state with ultrasound and blow the solution with a fan or a steam fan atomizer 61b configured to heat and evaporate the solution and blow the solution with a fan.

FIG. 7 is a diagram of an exemplary configuration of solution applying rollers according to this embodiment.

Solution applying rollers 62 apply the solution to a medium with rollers. The solution applying rollers 62 include elastic rollers or non-elastic rollers. As the elastic rollers according to this embodiment, rubber rollers or sponge rollers (e.g., PVA sponge rollers excellent in hydrophily and water retentivity) are used. As the non-elastic rollers, metal rollers or rollers obtained by coating a film having a water retaining function on the metal rollers (a film having fine unevenness on the surface) are used. When paper is not fed to the solution applying unit 60, components opposed to the solution applying rollers 62 are separated from the solution applying rollers 62 by a cam. Consequently, the solution is prevented from being applied to components opposed to the solution applying rollers 62.

As the solution to be applied, liquid with viscosity or the like thereof adjusted, water, treatment liquid for improving image quality and water resistance, or the like can be used. For example, the treatment liquid includes an additive such as a wetting agent or a surface active agent for improvement of wettability in moisture of about 30 to 80 weight %. The solution to be applied once per one piece of A4 paper (plain paper 5g/A4) is set to about 0.05 g to 0.3 g (1% to 6%).

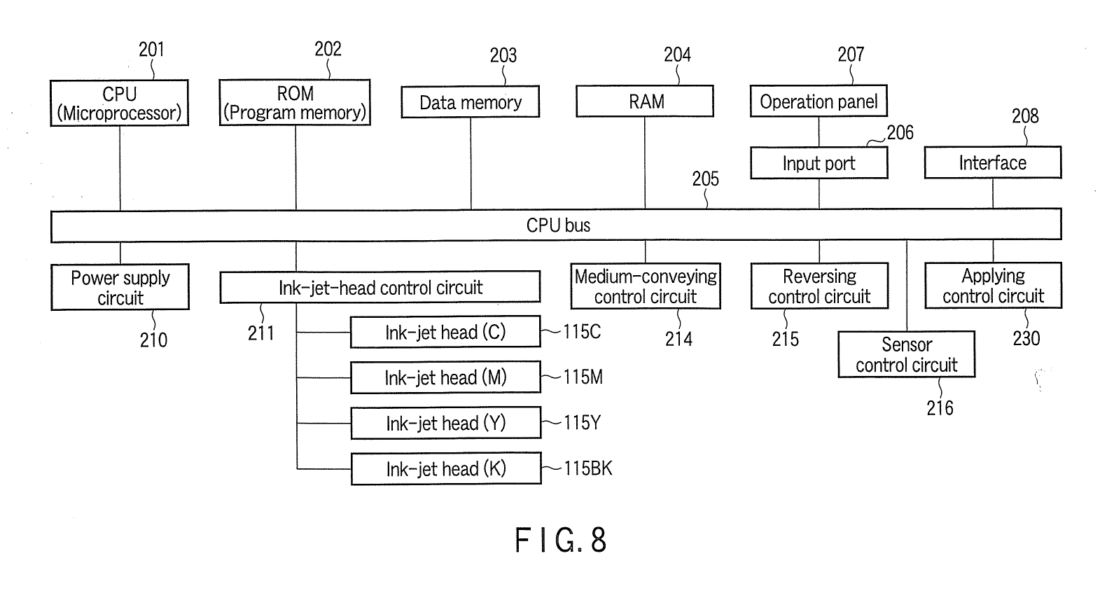

FIG. 8 is a diagram of an exemplary configuration of a control system of the ink-jet image forming apparatus according to this embodiment.

The control system of the ink-jet image forming apparatus 1 includes a CPU (a micro processor) 201, a ROM (a program memory) 202, a data memory 203, a RAM (a working memory) 204, a CPU bus 205, an input port 206, an interface 208, a power supply circuit 210, and an ink-jet-head control circuit 211, a medium-conveying control circuit 214, a reversing control circuit 215, a sensor control circuit 216, and an applying control circuit 230.

The CPU (the microprocessor) 201 collectively controls the units of the ink-jet image forming apparatus 1. The ROM (the program memory) 202 and the RAM (the working memory) 204 are connected to the CPU 201 via the CPU bus 205 to form a micro computer. The ROM 202 or the data memory 203 has stored therein an operation program for executing driving control. The input port 206 exchanges information with an operation panel 207. The interface 208 exchanges information with an external computer.

The ink-jet-head control circuit 211 drives the ink-jet heads 31 to operate. The medium-conveying control circuit 214 drives conveying means such as a driving roller 22a and a driven roller 22b. The reversing control circuit 215 controls the operation of the medium reversing unit 50. The sensor control circuit 216 controls detection operations of the temperature and humidity detection sensor 64 and the paper thickness detection sensor 65. The applying control circuit 230 controls the operation of the solution applying unit 60. The power supply circuit 210 supplies a power supply voltage to the units of the ink-jet image forming apparatus 1. The power supply circuit 210 also outputs a driving voltage for the ink-jet heads 31 and a motor driving voltage for driving of the medium conveying unit 20.

The operation of the ink-jet image forming apparatus 1 is explained below. The units of the ink-jet image forming apparatus 1 are basically controlled by the CPU 201. The units are controlled according to the operation program stored in the ROM 202 or the data memory 203. First, image data and a printing command transmitted from an external computer via the interface 208 are transferred to the RAM (the working memory) 204. The image data and the printing command are processed by the CPU 201 on the basis of the operation program stored in the ROM (the program memory) 202, command data stored in the data memory 203, and the like.

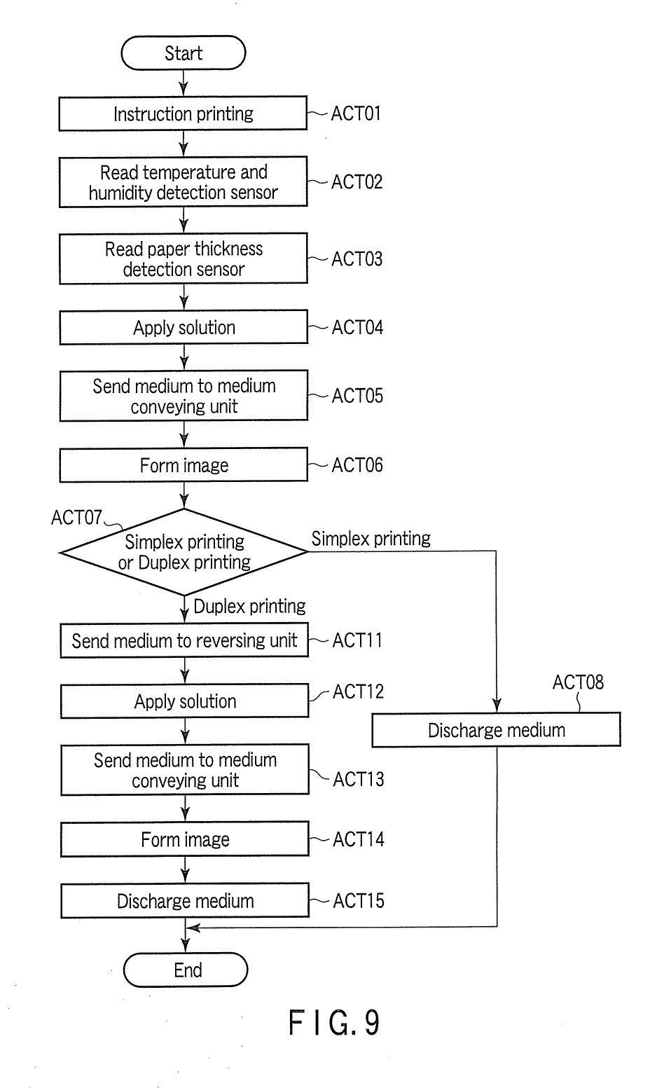

FIG. 9 is an exemplary flowchart for explaining an image forming operation procedure of the ink-jet image forming apparatus according to this embodiment.

In Act 01, a user gives an instruction for print to the ink-jet image forming apparatus 1. In Act 02, the CPU 201 acquires the temperature and the humidity of the medium storing unit 40 detected by the temperature and humidity detection sensor 64. The CPU 201 determines, from the acquired temperature and humidity, an application amount 1 of a solution applied by the solution applying unit 60.

In Act 03, the CPU 201 picks up a medium from the medium storing unit 40. The paper thickness detection sensor 65 acquires the thickness of the picked-up medium. The CPU 201 determines a predetermined application amount 2 corresponding to the acquired thickness of the medium.

In Act 04, the CPU 201 determines an application amount of the solution applied to the medium and applies the solution to the medium using the solution applying unit 60. An application amount N1 of the solution applied to the medium is a sum of the application amount 1 and the application amount 2. The application amount N1 is set to 1% to 6% of the weight of the medium. A reason for the setting is explained later.

A surface of the medium to which the solution applying unit 60 applies the solution is a surface to be printed (the front surface). The solution is uniformly applied to the front surface of the medium. This embodiment is not limited to a form of uniformly applying the solution. Plural areas to which the solution is applied may be set on the front surface of the medium to include a portion with high printing density.

In Act 05, the medium applied with the application amount N1 of the solution on the front surface thereof by passing through the solution applying unit 60 is sent to the medium conveying unit 20. In Act 06, an image is formed on the medium sent to the medium conveying unit 20 while the medium passes below the ink-jet-head mounted unit 30.

In Act 07, the CPU 201 checks whether a printing mode is the simplex printing mode or the duplex printing mode. In the case of the simplex printing mode, in Act 08, the medium is discharged to the outside of the ink-jet image forming apparatus 1 and the print ends.

In the case of the duplex printing mode, in Act 11, after passing below the ink-jet-head mounted unit 30, the medium is sent to the medium reversing unit 50 and reversed. In Act 12, the medium passes through the solution applying unit 60 again. The application amount N2 of the solution is 1% to 6% of the weight of the medium on the rear surface of the front surface of the medium, i.e., the surface printed before the reversal. However, during the duplex printing, unlike during the simplex printing, the solution is applied to satisfy a condition 1: the application amount N1+the application amount N2<1% to 6% and a condition 2: the application amount N1 the application amount N2.

The condition 1: the application amount N1+the application amount N2<1% to 6% is provided because, when a humidification amount increases, moisture in the medium excessively increase, long time is required to dry the medium, and handling of the medium after print is difficult. The condition 2: the application amount N1 the application amount N2 is provided because, since humidification and printing are already performed in the first print and the medium contains a lot of moisture, an application amount can be reduced in the second print.

In Act 13, the medium having the application amount N2 of the solution applied thereon by passing through the solution applying unit 60 is sent to the medium conveying unit 20. In Act 14, an image is formed on the medium sent to the medium conveying unit 20 while the medium passes below the ink-jet-head mounted unit 30. In Act 15, the medium is discharged to the outside of the ink-jet image forming apparatus 1 and the print ends.

Application conditions are not limited to the application conditions explained in Act 12. Application amounts may be controlled. For example, as another condition, the application amount N1 in the first print during the duplex printing is set smaller than the application amount N in the simplex printing. The application amount N2 in the second print is also set small. In other words, a relation of a condition 3: the application amount N≧the application amount N1≧the application amount N2 may be provided. The control of the application amounts is executed by changing conveying speed of the medium.

FIG. 10 is an exemplary diagram for explaining an effect of a reduction in cockling realized when moisture is applied in the ink-jet image forming apparatus according to this embodiment. In FIG. 10, the abscissa represents an application ratio and the ordinate represents an amount of occurred cockling.

An apparatus used for this test includes a medium conveying mechanism configured to convey a medium and an ink-jet head mechanism configured to form an image. Three kinds of media were used for the test: (i) a medium not applied with the solution, (ii) a medium applied with the solution by an amount of 2% of the weight of the medium (on the front surface), and (iii) a medium applied with the solution by an amount of 4% of the weight of the medium (on the front surface). The three kinds of media were respectively fed, images were formed on the media, and cockling was measured by a laser displacement gauge immediately after printing. Several peaks of measure waveforms were picked up from the top and averages of the peaks were compared.

In a test result shown in FIG. 10, since cockling is larger in such order as (iii)<(ii)<(i), it is seen that there is an effect in a reduction of cockling by increasing moisture to be applied.

A reason for setting an amount of the moisture to 1% to 6% of the weight of the medium is explained below with reference to FIG. 10. The test shown in FIG. 10 was performed in an environment with temperature of 23° C. and humidity of 50%. The effect of a reduction in cockling appears up to a predetermined value of the application ratio. A further effect of a reduction in cockling is not obtained even if the moisture more than the predetermined amount is applied. Conversely, when an application amount is excessively large, time required for drying after discharge is extended and the humidity in the apparatus rises. Therefore, it is highly likely that rust occurs in the components and the components are deteriorated.

In FIG. 10, an application amount of 1% to 4% of the weight of the medium is considered to be appropriate for a reduction in cockling. In the case of a sheet left untouched under a low humidity environment (23° C., 25%), moisture content is small by 0.09 g compared with the test environment (23° C., 50%). This is equivalent to 2% of paper weight. When the sheet left untouched under the low humidity environment is also taken into account, 1% to 6% is a value suitable as an application amount for reducing cockling.

A method of determining whether humidification of a medium is executed is explained below. It is known that deformation (curl and cockling) of the medium increases in proportion to a moisture amount of ink and a deformation amount changes according to moisture content of the medium. For example, a medium with high moisture content has a small deformation amount and a medium with low moisture content has a large deformation amount.

In this embodiment, a medium is humidified under conditions explained below.

(1) In an environment of use of the apparatus or a paper feeding cassette environment, when humidity is equal to or lower than 70%, humidification is executed. When humidity exceeds 70%, since a deformation amount is small, it is unnecessary to humidify the medium.

(2) When ink with a large moisture amount (moisture equal to higher than 20%) is used, humidification is executed. Humidification is executed according to the test result. For example, a deformation amount is small with oil-based ink not containing moisture.

(3) When a region of high-density solid printing (equal to or higher than 50%) is present and an area of the region is equal to or larger than 100 mm², humidification is executed.

(4) When high-density solid printing (equal to or higher than 50%) is executed in an area equal to or larger than 50% of a total area of the medium, humidification is executed.

(5) During the duplex printing, humidification is executed.

(6) When basis weight of paper is equal to or smaller than 110 g/m², humidification is executed.

A condition for a moisture amount for humidification may be changed stepwise according to the conditions (1) to (6). The condition for a moisture amount for humidification may be changed according to any one of the conditions (1) to (6) or a combination of several conditions.

In the case of the duplex printing, timing for humidification can be selected from A to C below and changed according to the conditions (1) to (6).

A. A front surface before printing of a first surface+a front surface in printing of a second surface

B. Only the front surface before the printing of the first surface

C. Only the front surface before the printing of the second surface

With the configuration and the control explained above, deformation (cockling and curl) of paper caused when printed by water-based ink can be reduced by applying a solution to a medium by an amount of 1% to 6% of the weight of the medium.

The functions explained in the embodiment may be configured by using hardware or may be realized by causing a computer to read a computer program describing the functions using software. The functions may be configured by selecting the software or the hardware as appropriate.

Further, the functions can also be realized by causing the computer to read a computer program stored in a not-shown recording medium. A recording format of the recording medium in the embodiment may be any form as long as the recording medium can record the computer program and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink-jet image forming apparatus comprising:
an ink-jet head which ejects water-based ink and form an image on a surface of a recording medium;
a medium conveying unit which conveys the recording medium;
a solution applying unit arranged further on an upstream side in a recording medium conveying direction than the ink-jet head and applies water solution to a surface of the recording medium on which an image is formed; and
a controller configured to calculate an application amount of the water solution to apply the water solution to the recording medium at 1% to 6% of weight of the recording medium and control an application operation to the recording medium.

2. The ink-jet image forming apparatus according to claim 1, wherein the water solution is water or processing liquid added with a wetting agent or a surface active agent.

3. The ink-jet image forming apparatus according to claim 1, wherein the controller calculates an application amount of the water solution from thickness of the recording medium and temperature and humidity of an environment of use of the apparatus.

4. The ink-jet image forming apparatus according to claim 1, wherein the controller calculates an application amount of the water solution on the basis of an environment of use of the apparatus.

5. The ink-jet image forming apparatus according to claim 4, further comprising:
a temperature and humidity detection sensor; and
a paper thickness detection sensor.

6. The ink-jet image forming apparatus according to claim 5, further comprising a recording-medium reversing unit which reverses, after an image is formed on one surface of the recording medium, a front and a rear of the recording medium in order to form an image on another surface of the recording medium.

7. The ink-jet image forming apparatus according to claim 6, wherein the controller control an operation for applying the water solution to the recording medium if at least one of following conditions is satisfied:
(1) the environment of use of the apparatus is equal to or lower than predetermined humidity;
(2) a moisture amount of ink used for printing is equal to or higher than a predetermined percentage;
(3) an area of a region where a printing ratio is equal to or higher than a predetermined percentage is equal to or larger than predetermined square millimeters;
(4) the region where the printing ratio is equal to or higher than the predetermined percentage is printed in an area equal to or larger than a predetermined percentage of a total area of the medium;
(5) print is executed in a duplex printing mode; and
(6) basis weight of the recording medium is equal to or smaller than a predetermined value.

8. The ink-jet image forming apparatus according to claim 6, wherein the solution applying unit applies the water solution to the recording medium with a roller.

9. The ink-jet image forming apparatus according to claim 6, wherein the solution applying unit sprays and applies the water solution to the recording medium.

10. The ink-jet image forming apparatus according to claim 1, further comprising a recording-medium reversing unit which reverses, after an image is formed on one surface of the recording medium, a front and a rear of the recording medium in order to form an image on another surface of the recording medium.

11. The ink-jet image forming apparatus according to claim 10, wherein, in a duplex printing mode, the controller controls operations of the recording-medium conveying unit and the solution applying unit to apply the water solution to another surface of the recording medium.

12. The ink-jet image forming apparatus according to claim 11, wherein, in the duplex printing mode, the controller calculates an application amount such that a following relation holds between an application amount N1 on the one surface and an application amount N2 on the other surface:
N1+N2<1% to 6%, N1≧N2

13. The ink-jet image forming apparatus according to claim 1, wherein the solution applying unit applies the water solution to the recording medium with a roller.

14. The ink-jet image forming apparatus according to claim 1, wherein the solution applying unit sprays and applies the water solution to the recording medium.

15. An image forming method for an ink-jet image forming apparatus including: an ink-jet head which ejects water-based ink and form an image on a surface of a recording medium; and a solution applying unit which applies water solution to a surface of the recording medium on which an image is formed, the method comprising:
calculating an application amount of the water solution to apply the water solution to the recording medium at 1% to 6% of weight of the recording medium; and
controlling an application operation to the recording medium.

16. The image forming method according to claim 15, further comprising calculating the weight of the recording medium on the basis of information acquired from a paper thickness detection sensor.

17. The image forming method according to claim 15, further comprising calculating the application amount of the water solution applied to the recording medium on the basis of information acquired from a temperature and humidity detection sensor.

18. The image forming method according to claim 15, further comprising calculating the application amount of the water solution on the basis of an environment of use of the ink-jet image forming apparatus.
